(19) United States
(12) Patent Application Publication
(10) Pub. No.: US 2015/0081580 A1
(43) Pub. Date: Mar. 19, 2015

(54) VIDEO RECORD RECEIPT SYSTEM AND METHOD OF USE

(71) Applicant: JAMES BRIAN FRY, ELGIN, TX (US)

(72) Inventor: JAMES BRIAN FRY, ELGIN, TX (US)

(21) Appl. No.: 14/029,801

(22) Filed: Sep. 18, 2013

(51) Int. Cl. G06Q 50/28

(52) U.S. Cl. CPC G06Q 50/28
USPC 705/330; 705/1.1

(57) ABSTRACT

A system is provided to generate a video receipt for purposes of creating evidence of shipment of a package to an intended recipient. The kiosk includes a secure drop box into which packages may be placed for later pick up by a shipping service, a computer system having a user interface and means for communicating wired or wirelessly via a public or private network; an electronic communication application installed on the computer system permitting the electronic transfer of a video receipt and text, and a video camera secured to the kiosk and actuatable by the person desiring to ship one or more packaged items via the user interface of the computer.

### BACKGROUND

The embodiments herein relate generally to a system and method of using a system to create a video record receipt relating to the shipment of packages. Today, it has become commonplace for persons generally unknown to each other to send packages from one to the other, whether it is from a commercial distribution company, such as amazon.com® or the like, or an individual through services like eBay®. The problem is that sometimes a package does not arrive or arrives damaged, and the sender wants to be able to show that the package was actually sent, was sent to the correct address and was not damaged when deposited with the shipping company. Disputes relating to such events occur frequently, with many ending up in litigation. A written record is often provided for shipping transactions, but written records still leave room for dispute. Thus, a need exists for an improved way to prove when a package has been properly and safely shipped to the appropriate recipient.

### SUMMARY

A system and method of generating a video receipt is provided for purposes of creating evidence of shipment of one or more packaged items from one person to an other person. Such evidence can means of proving that the one person sent the one or more packaged items to the other person when the other person contends that such one or more packaged items were not received. In one application, the method comprises bringing one or more packaged items to a kiosk configured to be placed in one of numerous locations convenient for persons who wish to ship packaged items to an other person, establishing a connection with a public or private network via a user interface of a computer system within the kiosk in order to enter information about the desired shipment of the one or more packaged items desired to be shipped, actuating a video camera provided on the kiosk to record the placement of the one or more packaged items into a drop box in the kiosk by the person; and sending at least a portion of the video, via an electronic communication application installed on the computer system, to the intended recipient of the one or more packaged items to show the recipient that the one or more packaged items have in fact been securely shipped. In some embodiments, the computer system may include a database configured to store video recordings generated by persons who place the one or more packaged items into the drop box for shipment. In other embodiments, the kiosk is portable and configured sufficiently small to permit users to set up the kiosk at home in a manner that permits one or more shipping services to access the one or more packaged items securely placed into the drop box.

In one embodiment of the present invention, a system is provided to generate a video receipt for purposes of creating evidence of shipment, as discussed above. In some examples, the kiosk comprises a secure drop box into which the one or more packaged items may be placed for later pick up by a shipping service, a computer system comprising a user interface and means for communicating wired or wirelessly via a public or private network; an electronic communication application installed on the computer system permitting the electronic transfer of a video receipt and text, and a video camera secured to the kiosk and actuatable by the person desiring to ship one or more packaged items via the user interface of the computer. The computer system may include a database for storing video files as well.

### BRIEF DESCRIPTION OF THE FIGURES

The detailed description of some embodiments of the invention will be made below with reference to the accompanying figures, wherein like numerals represent corresponding parts of the figures.

FIG. 1 shows a schematic perspective view of one embodiment of the present invention;

FIG. 2 shows a schematic side view of the embodiment of FIG. 1; and

FIG. 3 shows a flow chart of one application of a method of using embodiments of the present invention.

### DETAILED DESCRIPTION OF CERTAIN EMBODIMENTS

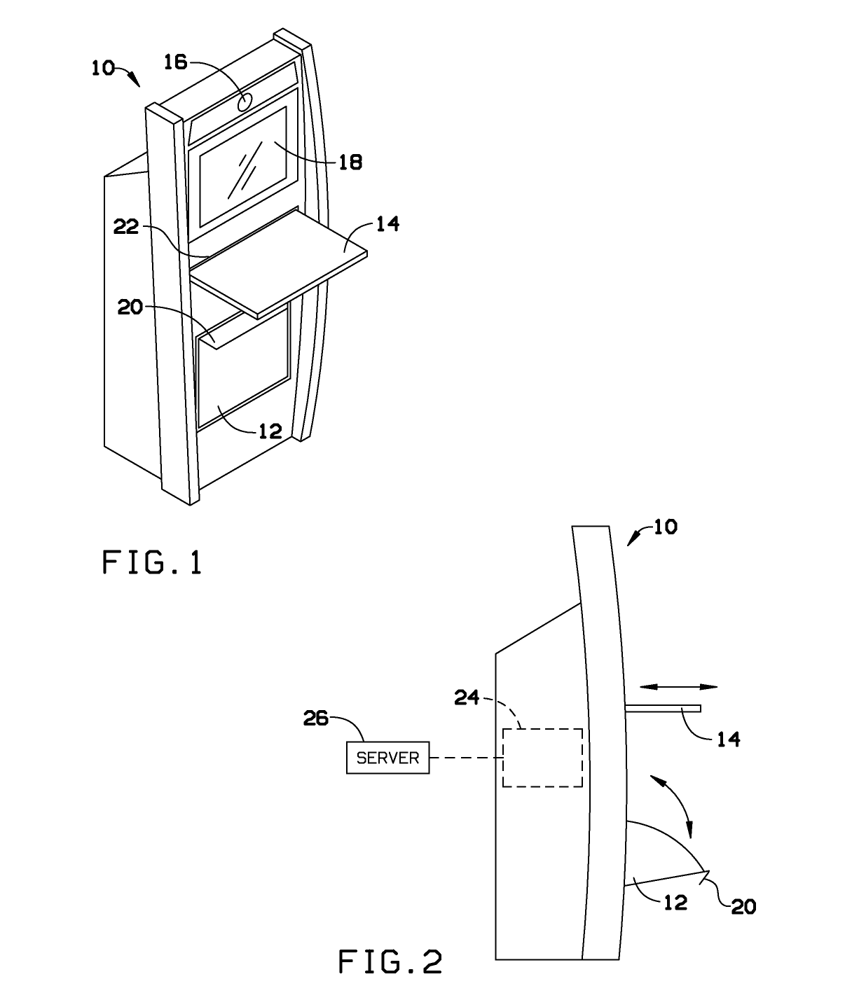

By way of example, and referring to FIGS. 1 and 2, one embodiment of the present invention comprises a kiosk 10 of any shape or size generally, but configured to be placed accessibly in a public place for those who wish to send packages. The particular example of embodiment shown in FIG. 1 has a generally vertical orientation not unlike airline ticket kiosks.

In one embodiment, system 10 comprises a drop box 12 with handle 20 configured to permit a user to open the drop box and place a package into the drop box 12 so that when closed the package is inaccessible except by an authorized shipping agent. In that regard, a locked door may be provided on the back of the system kiosk 10 to permit such an agent to retrieve packages for shipment later. In some embodiments, a retractable surface 14 may be provided to permit a user to conduct business while using the system. As shown in FIG. 2, the retractable surface 14 may slide horizontally into and out of the kiosk as needed. It could also be a pull down table if so desired. Numerous configurations of a work surface are contemplated.

The kiosk preferably also comprises a video camera 16 mounted on or within, or merely just connected to, the kiosk 10 in a manner that permits the user to record the shipment transaction they wish to conduct. In the case of the example shown, the video camera 16 is mounted proximate the top of the kiosk 10 so that the user is in view. The angle of the video camera, either as permanently mounted, or as mounted in a rotatable or adjustable fashion, is preferably such that the camera may capture a video of the user placing one or more packages into the drop box 12.

In that regard, the kiosk 10 preferably includes a computer system 24 having a graphic user interface 18, a means for connecting to a public or private network, including the Internet, and a means for electronically communicating with one or more recipients. In some examples, the graphic user interface comprises a touch screen 18, or it may comprise a monitor electronically (wired or wirelessly) coupled to a keyboard that may reside on the work surface 14 or may be stored from a hook or space within the kiosk 10.

The connecting and communicating means are preferably applications downloadable to the computer system 24 or software that can be installed onto the computer system 24 to permit the user access to the network and to send a video file and possibly also a text file or image file to a recipient. It is contemplated that the application or software is configured to permit a user to establish an account with the provider of the system for secure shipping of packages and to ensure appropriate authentication. The application and/or software may reside on the computer system 24 or on a server 26 in electrical communication (wired or wirelessly) with the computer system 24.

It is also contemplated that the recipient of the video and possible other electronic communication be either the intended recipient of the package or an intermediary in case the recipient desires to remain relatively incognito. The recipient may simply be the shipping company tasked with ensuring that the package safely arrives at its intended destination, where the shipping company sends the video recording the package recipient to prove that it has been sent, and then follows up by sending the package.

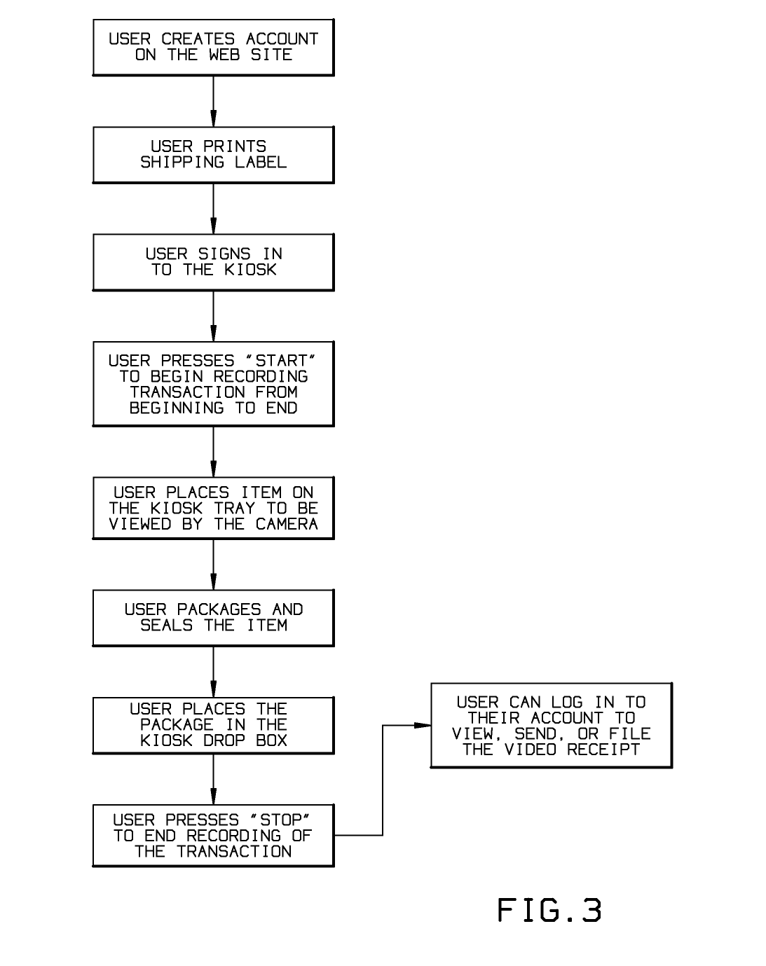

Of course, one method is where the user video records the package and the insertion of the package into the drop box, and then, by way of the user's account and use of the computer system, emails, texts or otherwise electronically sends the video recording to the intended package recipient to show that the package has been handed off, so to speak. More specifically, and referring to FIG. 3, one example of a method of use of the present invention comprises a user creating an account on a website of a web-based secure shipping application, printing labels for the package from a label printer (not shown) provided on the kiosk, signing into the user's account, actuating the video camera to commence recording of the package and/or wrapping of the package, placing the package or packages into the drop box, stopping the recording session, and then transmitting the video file to a recipient as a video receipt. With this and other methods of the present invention, regardless of who the intended recipient of the video recording is, if the package does not arrive, the video recording may be used by the sender as evidence that the package was sent.

It is also contemplated that embodiments of the present invention herein permit a user to pick up a package. In other words, such embodiments may be configured for the package “recipient” to log into their account, pick up their package, and acknowledge to the sender that the package has been received. If there are any damage or item issues relating to the package, the “recipient” can video record the package as received and transmit to the sender the exact condition as received. In this way, both the sender and the recipient have video evidence of the package as sent and as received, respectively.

In other applications, the present invention may be employed by business establishments at points-of-sale locations for the protection of customers. As many will appreciate, for years, customers have ordered desired items (e.g., at a fast food restaurant) or have brought to a cashier desired items (e.g., at a retail store) for purchase only to arrive home and find that one of the items paid for is missing from the bag. That is a very frustrating situation because now it's the word of the customer versus the word of the cashier. In a perfectly honest world, or a world in which the business establishment believes that “the-customer-is-always-right,” such problems would be easily remedied. But they are very often not satisfactorily remedied by the business establishment, to the consternation of the customer. Thus, to solve that issue, the present invention includes a methodology involving customer transactions in which a video camera is positioned, for example at a point-of-sale location, so that the bagging of the items purchased may be recorded to show exactly which items were placed into the bag(s) at the time of purchase. The video recording would then be saved to a database by the business establishment, where the recording may then be offered to customers as a “video receipt” of the transaction.

In one embodiment of this methodology, the database is made accessible to the customer from a web-site created by the business establishment to permit the customer to view the video receipt based upon the input of certain identifying information about the transaction. For example, the paper receipt received by the customer might have a transaction number, which the customer could input into the web page to retrieve and view the video receipt. Or, in case the paper receipt is misplaced or lost, the customer might enter the time of the transaction and identify some or all of the items purchased, to permit the web-based system to properly identify which of the transactions the customer was involved in, in order to retrieve the video receipt. In such methodologies, where a discrepancy has occurred between what a customer paid for and what the customer received can be resolved more accurately. Indeed, such a video receipt could also beneficially serve to protect a person from identity theft. For example, if a business establishment is seeking to collect payment from a person based upon an allegation that the person received goods or services from the business, but it was not the person who actually received the goods or services, the alleged person can be permitted to view the video recording of the transaction to prove that it was a different person, not the alleged person. Thus, it is contemplated that the invention herein includes systems and methods implemented by businesses for point-of-sale transactions or, candidly, any type of transaction to safeguard the customers from incomplete service or identity theft.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A method of generating a video receipt for purposes of creating evidence of shipment of one or more packaged items from one person to an other person so as to provide means of proving that the one person sent the one or more packaged items to the other person when the other person contends that such one or more packaged items were not received, the method comprising:
bringing one or more packaged items to a kiosk configured to be placed in one of numerous locations convenient for persons who wish to ship packaged items to an other person, the kiosk comprising (a) a secure drop box into which the one or more packaged items may be placed for later pick up by a shipping service, (b) a computer system comprising a user interface and means for communicating wired or wirelessly via a public or private network; and (c) a video camera secured to the kiosk and actuatable by the person desiring to ship one or more packaged items via the user interface of the computer;
establishing a connection with the public or private network via the user interface in order to enter information about the desired shipment of the one or more packaged items desired to be shipped;
actuating the video camera to record the placement of the one or more packaged items into the drop box by the person; and
sending at least a portion of the video, via an electronic communication application installed on the computer system, to the intended recipient of the one or more packaged items to show the recipient that the one or more packaged items have in fact been securely shipped.

2. The method of claim 1, wherein the computer system further comprises a database configured to store video recordings generated by persons who place the one or more packaged items into the drop box for shipment.

3. The method of claim 1, wherein the kiosk is portable and configured sufficiently small to permit users to set up the kiosk at home in a manner that permits one or more shipping services to access the one or more packaged items securely placed into the drop box.

4. The method of claim 1, wherein the private network is hosted by a shipping service so that persons who desired to record the shipment of one or more packaged items can establish accounts by which secure shipment may be provided.

5. A system configured to generate a video receipt for purposes of creating evidence of shipment of one or more packaged items from one person to an other person so as to provide means of proving that the one person sent the one or more packaged items to the other person when the other person contends that such one or more packaged items were not received, the system comprising a kiosk configured to be placed in one of numerous locations convenient for persons who wish to ship packaged items to an other person, the kiosk comprising:
a secure drop box into which the one or more packaged items may be placed for later pick up by a shipping service,
a computer system comprising a user interface and means for communicating wired or wirelessly via a public or private network; and
a video camera secured to the kiosk and actuatable by the person desiring to ship one or more packaged items via the user interface of the computer;
wherein the system is configured so that a user may establish a connection with the public or private network via the user interface in order to enter information about the desired shipment of the one or more packaged items desired to be shipped, the user can then actuate the video camera to record the placement of the one or more packaged items into the drop box by the person, and the user can send at least a portion of the video to the intended recipient of the one or more packaged items to show the recipient that the one or more packaged items have in fact been securely shipped.

6. The system of claim 5, wherein the system further comprises a database configured to store video recordings generated by users who place the one or more packaged items into the drop box for shipment.

7. The system of claim 5, wherein the kiosk is portable and configured sufficiently small to permit users to set up the kiosk at home in a manner that permits one or more shipping services to access the one or more packaged items securely placed into the drop box.

8. A method of reconciling what a customer purchases with what the customer receives, the method comprising:
providing a video camera at a location within a business establishment where customer transactions occur;
initiating the video camera to record a customer transaction so that the video camera records items that the customer is purchasing being placed within a bag;
discontinuing the recording by the video camera when the customer transaction has finished and the customer has moved away from the camera with the bag; and
saving the video recording of the customer transaction to an electronic database for access by the customer later where the customer determines that there may be a discrepancy between what the customer purchased and what the customer received.

9. The method of claim 8, further comprising establishing a web-site accessible by the customer where the web-site is configured to receive data input by the customer about the transaction to permit the customer to view the video recording associated with the transaction.
